(19) United States
(12) Patent Application Publication
(10) Pub. No.: US 2012/0087596 A1
(43) Pub. Date: Apr. 12, 2012

(54) METHODS AND SYSTEMS FOR PIPELINED IMAGE PROCESSING

(76) Inventors: Pawankumar Jagannath KAMAT, Bangalore (IN); Serene Banerjee, Bangalore (IN); Sreenath Ramanna, Bangalore (IN); Anjaneyulu Seetha Rama Kuchibhotla, Bangalore (IN); Kadagattur Gopinatha Srinidhi, Bangalore (IN)

(21) Appl. No.: 12/968,281

(22) Filed: Dec. 15, 2010

(30) Foreign Application Priority Data
Oct. 6, 2010 (IN) 2954/CHE/2010

(51) Int. Cl. G06K 9/40

(52) U.S. Cl. 382/254; 382/303

(57) ABSTRACT

A system and method for pipeline image processing is disclosed. In one example embodiment the one or more swaths of the image may be received on the server from a client device connected to the server via a network. The received one or more swaths are processed on a swath by swath basis to obtain one or more image quality parameters. The obtained one or more image quality parameters are compared with a predetermined threshold level. The obtained one or more image quality parameters may be sent to the client device for further processing of the image based on the obtained one or more image quality parameters.

### RELATED APPLICATIONS

Benefit is claimed under 35 U.S.C. 119(a)-(d) to Foreign application Serial No. 2954/CHE/2010, filed in INDIA entitled “METHODS AND SYSTEMS FOR PIPELINED IMAGE PROCESSING” by Hewlett-Packard Development Company, L.P., filed on Oct. 6, 2010, which is herein incorporated in its entirety by reference for all purposes.

### BACKGROUND

An image is an artifact, for example a two-dimensional picture that has a similar appearance to some subject usually a physical object or a person. The image may be captured by optical devices such as cameras, scanners, all in one printers, etc. Usually the captured image does not meet user expectations and may contain some unwanted contents. Such images may be processed using image processing. Image processing is a form of signal processing for which an input is an image, such as a photograph and the output of image processing may be either an image or, a set of characteristics or parameters related to the image. Most image-processing techniques involve treating the image as a two-dimensional signal and applying standard signal-processing techniques to it.

Most of the image capturing devices have in-built image processing techniques to perform an initial image processing. For example, digital cameras generally include dedicated digital image processing chips to convert raw data from an image sensor into a color-corrected image in a standard image file format. Images from the digital cameras may be further processed to improve their quality. Since the digital image processing typically is executed by special software programs that can manipulate the images in many ways, these software programs tend to decrease a response time of the digital camera or use most of the processing resources for image processing. Some devices like scanners do not have much in-built processing capacities to carry out image processing. These imaging devices with limited processing capacities tend to use processors from outside the device to carry out the image processing, for example a personal computer. For using the processors from outside the imaging device, the imaging device has to send the captured image. Sending and receiving a high resolution large image may take significant amount of time and introduce significant latency.

### BRIEF DESCRIPTION OF THE DRAWINGS

Various embodiments are described herein with reference to the drawings, wherein:

FIG. 1 illustrates a flow diagram of a method for pipelined image processing in a networked computing environment, according to an embodiment;

FIG. 2 illustrates a block diagram of a method for skew correction and frame removal of an image, according to an embodiment;

FIGS. 3A, 3B and 3C illustrate an image, one or more swaths of the image and a histogram of skew angles of the one or more swaths respectively, according to an embodiment;

FIGS. 4A, 4B and 4C illustrate the one or more swaths of the image, skew corrected one or more swaths of the image and a skew corrected image respectively according to an embodiment;

FIGS. 5A and 5B illustrate a document image with blocks and a skew corrected document image respectively, according to an embodiment;

FIGS. 6A and 6B illustrate a document image with lines and a skew corrected document image respectively, according to an embodiment;

FIGS. 7A and 7B illustrate a large format geographic image and a skew corrected geographic image respectively, according to an embodiment;

FIGS. 8A and 8B illustrate a computer aided design (CAD) image and a skew corrected CAD image respectively, according to an embodiment;

FIGS. 9A and 9B illustrate a large format graphic image and a skew corrected large format graphic image respectively, according to an embodiment;

FIGS. 10A and 10B illustrate a large painting image and a skew corrected large painting image respectively, according to an embodiment;

FIGS. 11A and 11B illustrate an image of a railway ticket and a skew corrected image of the railway ticket respectively, according to an example embodiment;

FIG. 12 illustrates a table depicting examples of swath based skew detection and run-times on a workstation with an Intel Xeon 5160 processor at 3 GHz;

FIG. 13 illustrates a block diagram of a system for pipelined image processing, according to one embodiment; and

FIG. 14 illustrates another block diagram of a system for pipelined image processing, according to one embodiment.

The drawings described herein are for illustration purposes only and are not intended to limit the scope of the present disclosure in any way.

### DETAILED DESCRIPTION

A system and method for pipelined image processing is disclosed. In the following detailed description of the embodiments of the present subject matter, reference is made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

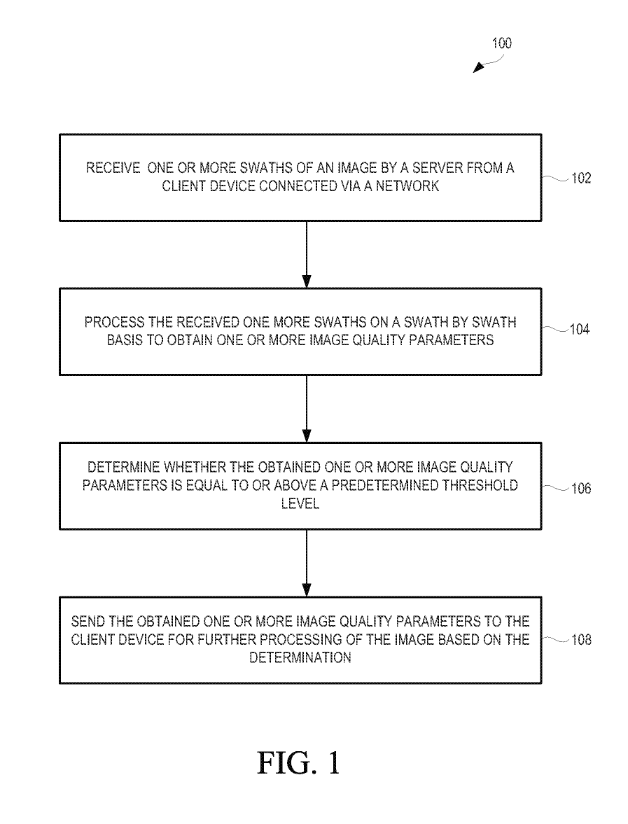

FIG. 1 illustrates a flow diagram 100 of an exemplary method for pipelined image processing. The method described herein proposes a real time swath based image processing, where otherwise loading a whole image is time consuming and bandwidth intensive. The method described in the present disclosure may be implemented in a networked computing environment. The networked computing environment may include a client device connected to a server. The network device may be connected to the server via an internet, wireless network and/or local area network. The network device may be connected to the server via a personal computing device. The client device may include an imaging device, for example a scanning device, a camera device, an all-in-one (printer, scanner and facsimile) device, a mobile phone device having a digital camera, and the like. The server device may be a single server and/or collection of one or more servers. The networked computing device may include a cloud computing environment. The cloud computing environment is an internet based computing system, whereby shared resources, software, and information are provided to computers and other devices on demand.

At block 102, one or more swaths of an image may be received by the server from the client device. The image to be processed may be captured by the client device. According to an embodiment, depending on the quality of the captured image the client device may determine one or more image processing services to be invoked on the server. According to another embodiment, the one or more image services may be invoked by a user of the client device. According to yet another embodiment, the one or more image processing services may be invoked by the server on the receipt of the one or more swaths of the image. The one or more image processing services to be invoked on the server may be determined while carrying out pre-processing of the image. As an example the one or more image processing services to be invoked may be determined when only first few swaths of the image are scanned in the scanning device.

Upon determination of the image processing services to be invoked on the server, the server may request the one or more swaths from the client device. The number of the swaths may be determined by the server depending on the image processing service to be invoked. The server may also determine a size of the swaths required for the image processing service. The number of swaths may be determined based on identifying a type of the image being processed and using predefined information about that type of the image. The server may communicate the required number of swaths to carry out the image processing to the client device. Upon receiving the required number of swaths and the size of the swaths from the server, the client device may determine bandwidth of the network between the client device and the server. According to an embodiment, the size of the swaths may be estimated based on image resolution, image size, and size of a memory available in the client device. As an example, for large format printer (LFP) devices, a swath is 2 inches of the image reduced to 50 dpi, for computation and memory optimization.

The client device may determine the bandwidth of the network with the help of the server. The server device may indicate the client device the number of swaths required by the image processing service or a non-sequential collection of swaths required by the image processing service. The client device may map the swaths required by the image processing service to the swaths available on the client device. The client device may perform the needed pre-processing and send the required swaths requested by the image processing service.

At block 104, the received one or more swaths may be processed on a swath by swath basis to obtain one or more image quality parameters. The one or more image quality parameters may be selected from the list consisting of a skew angle parameter, a frame removal parameter, a background removal parameter, a blur removal parameter, an edge detection parameter, and a text extraction parameter.

At block 106, the obtained one or more image quality parameters are determined to be equal to or above a predetermined threshold level. The threshold level may be determined by the user of the client device. The threshold level may also be computed by the server. For example, the threshold level may be determined by creating a histogram of the obtained image quality parameters to determine a mode and/or peaks of the histogram. The mode and/or the highest peak of the histogram may represent the image quality parameter of the image.

At block 108, the obtained one or more image quality parameters may be sent to the client device for further processing of the image based on the determination. According to an embodiment, the further processing of the image based on the obtained one or more parameters may be carried out on the server. The further processing of the image based on the obtained one or more parameters may be determined based on the processing speed of the client device, the bandwidth of the network between the client device and the server device and size of memory of the client device. According to an embodiment the further processing of the image may be carried out simultaneously on the client device and the server. According to another embodiment, the further processing of the image may be carried out simultaneously when the image is being captured on the client device.

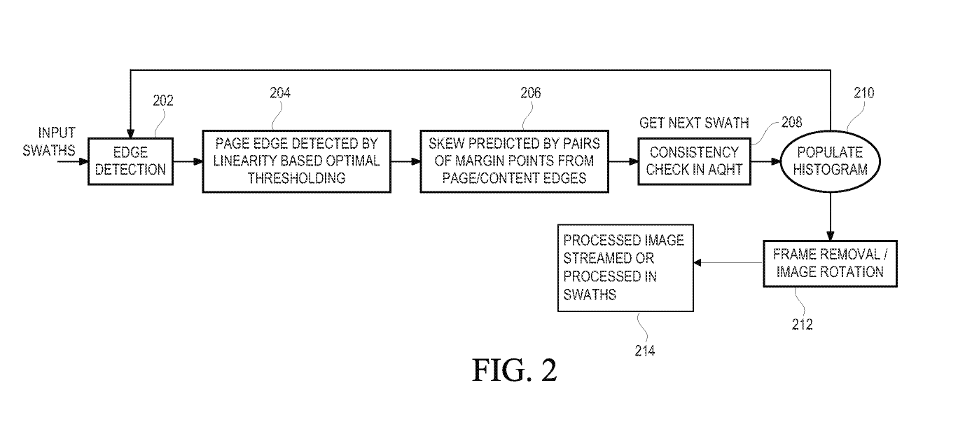

FIG. 2 illustrates a block diagram of a method 200 for skew correction and frame removal from an image, according to an embodiment. The method 200 may be carried out in a networked computing environment. The networked computing environment for carrying out method 200 may include a client device connected to a server. The computing environment may be a cloud computing environment with one or more servers connected together to form a cloud. The client device may be an image capturing device, for example a scanner, a camera, a mobile device with camera, etc. The client device may be connected to the server via a personal computer which is connected to the server via the internet and/or a local area network.

At block 202, the edges of the one or more swaths of the image are detected. The one or more swaths of the image may be received on the server from the client device. The received one or more swaths may be used for detecting page edge of the image. At block 204, the page edges may be detected using linearity based optimal thresholding method. As the page edges are straight lines separating the scan bed and the image, the gradient values are adaptively threshold in the acquired image based on linearity measure. The page edge detection using the linearity based optimal thresholding is robust to variations in charge coupled device (CCD) sensor outputs, lighting, image type and content, and background variations. The page edge detection using linearity based optimal thresholding may have an accuracy of about 100% even for low contrast images.

At block 206, the skew is predicted for each of the one or more swaths of the image by pairs of margin points from the page edges. For each swath, the page edges and/or the content edges are traced from all the four sides to get a set of points for each of the sides. An adaptive quasi hough transform (AQHT) is then applied to predict the skew angle for each of the one or more swaths. A histogram may be created using the detected skew angle of the one or more swaths. The estimated skew angle of the image is the mode of the angle histogram for all selected blocks of the swath. This process may be continued on the next N−1 swaths of the input image, where N is small compared to the total numbers of swaths in the image. The value of N used is generally small in a range of about 10. This value could however also be adaptively determined.

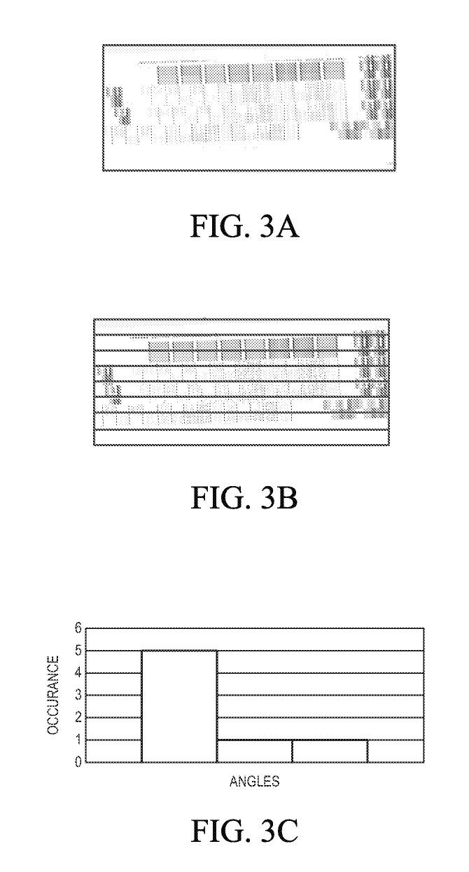

At block 208, a consistency check is performed in the AQHT. The consistency check may be performed to confidently predict the skew angle of the document. To confidently predict the skew for the whole document, the skew angles detected from the one or more swaths are combined. At block 210, the histogram may be populated. The histogram of all the angles detected for the one or more swaths is created, averaging close enough angles. The peak of the histogram may give the skew angle with the highest confidence. For more robustness, the difference of peaks between the first and the second maximas of the angle histogram may also be considered as a confidence measure for the skew angle. FIG. 3 shows an input image broken into the one or more swaths. The histogram of the skew angles of the one or more swaths has a peak at the correct skew angle of the image.

At block 212, the image may be processed to remove the frames. The image may further be processed to rotate by the determined skew angle. At block 214, the processed image may be sent to the client device for further processing. The processed image may be used for further processing on the server.

According to an embodiment, the image may be rotated in real time to correct the detected skew. For the user to have an experience of being able to print a skew-corrected image while it is being scanned, with minimal latency, it is desirable to rotate the image in real-time to enable pipelined printing. A swath based rotation algorithm based on three shear based image rotation may be implemented to efficiently rotate the image by maintaining and managing intermediate circular buffers. Theoretical calculations show that the first output swath can be obtained by buffering two input swaths, irrespective of the size, saving ˜80% of memory. Without this savings embedded rotation may not be possible, as the whole image may not be loaded in the limited memory of the client device. After rotation, the frame boundary may be drawn ensuring no content is deleted by adjusting the detected page edge so that it passes through the farthest content. As the image is rotated in swaths, parts of the document inside the frame boundary may be streamed in swaths, and downstream image processing services may commence. The pipeline is of low implementation complexity, and an embeddable fixed point version may be created for the LFP devices.

FIGS. 3A, 3B and 3C illustrate an image, the one or more swaths of the image and a histogram of the skew angles of the one or more swaths respectively, according to an embodiment. The image of FIG. 3A is divided into the one or more swaths depicted in FIG. 3B. A skew angle is detected for each of the one or more swaths and a histogram is created for the detected skew angle. The histogram is depicted in FIG. 3C. The peak of the histogram may indicate the skew angle of the image.

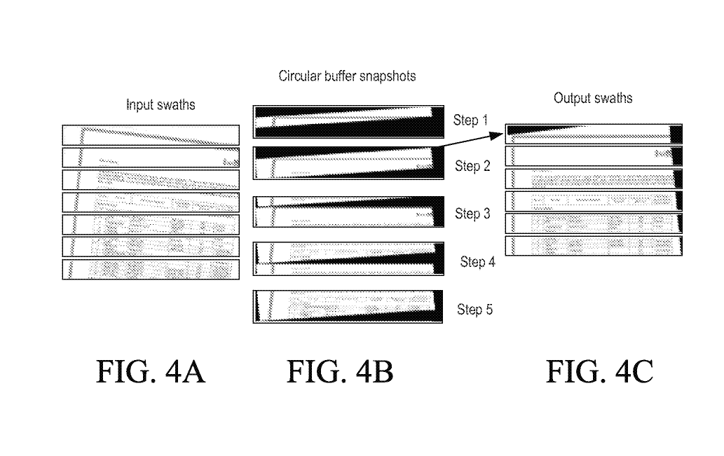

FIGS. 4A, 4B and 4C illustrate the one or more swaths of the image, skew corrected one or more swaths of the image and the skew corrected image respectively according to an embodiment. The one or more swaths may be corrected for the skew angle before sending it to the client device using buffers.

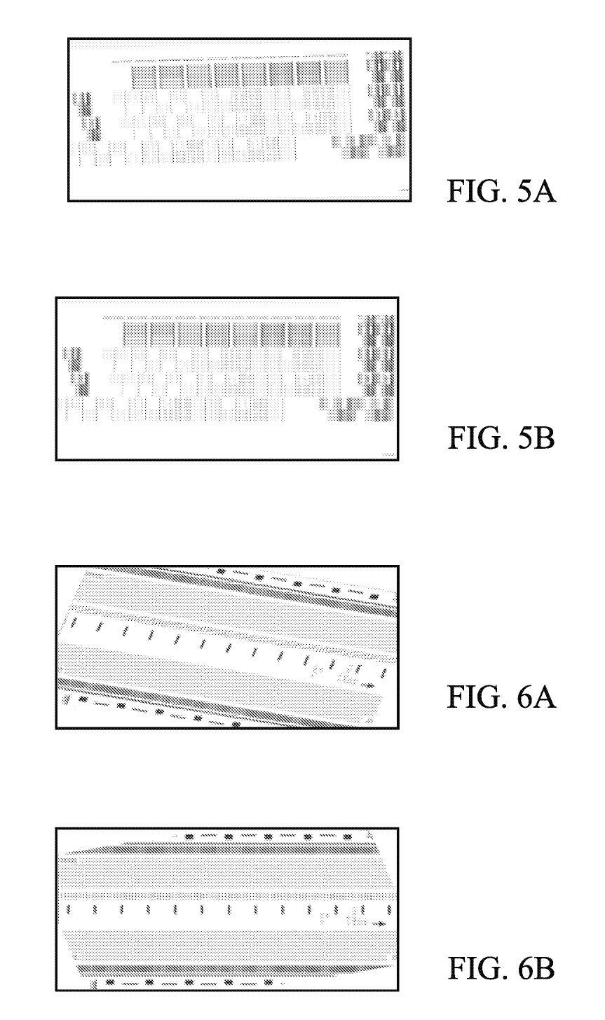

FIGS. 5A and 5B illustrate a document image with blocks and the skew corrected document image respectively, according to an embodiment.

FIGS. 6A and 6B illustrate a document image with lines and the skew corrected document image respectively, according to an embodiment.

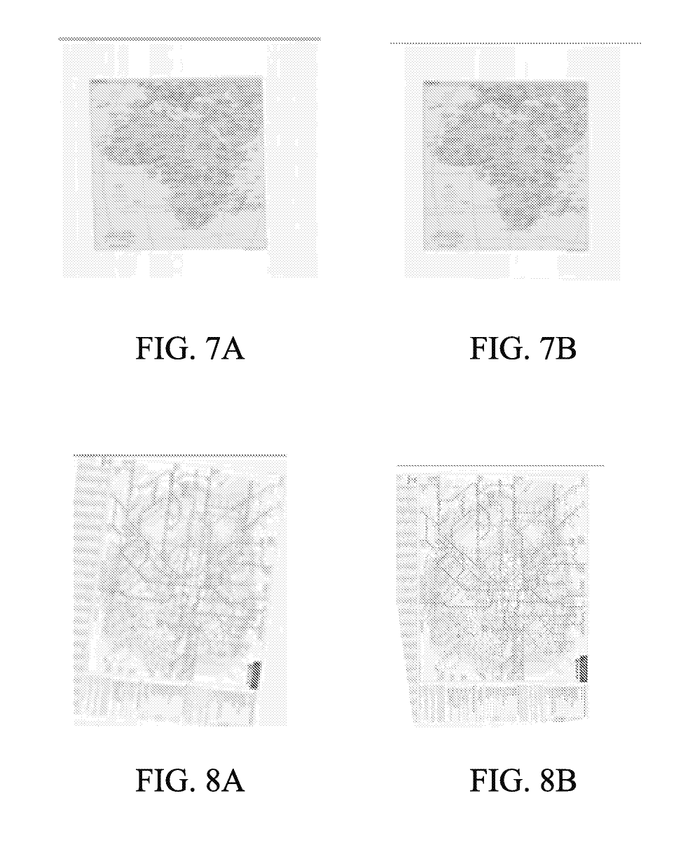

FIGS. 7A and 7B illustrate a large format geographic image and the skew corrected geographic image respectively, according to an embodiment.

FIGS. 8A and 8B illustrate a computer aided design (CAD) image and the skew corrected CAD image respectively, according to an embodiment.

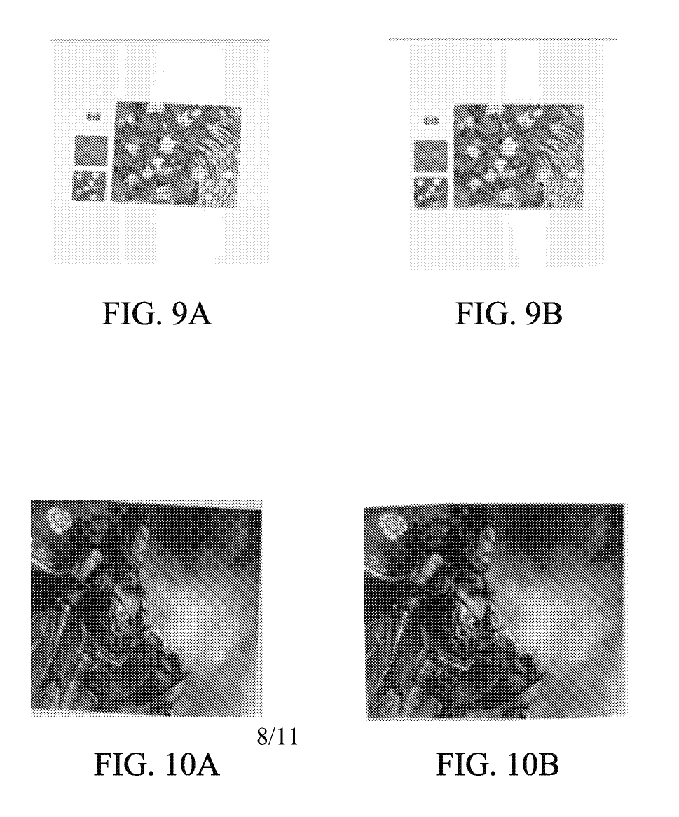

FIGS. 9A and 9B illustrate a large format graphic image and the skew corrected large format graphic image respectively, according to an embodiment.

FIGS. 10A and 10B illustrate a large painting image and the skew corrected large painting image respectively, according to an embodiment.

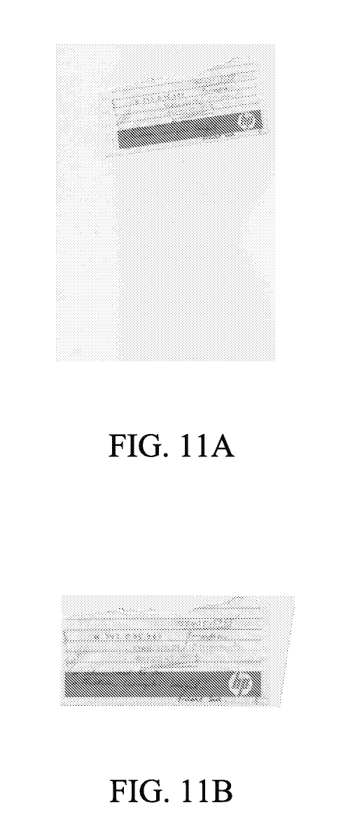

FIGS. 11A and 11B illustrate an image of a railway ticket and a skew corrected image of the railway ticket respectively according to an example embodiment. The skew corrected image of FIG. 11B of the railway ticket may be used to extract a passenger name record (PNR) number. The PNR number may be extracted by identifying the swath on which it may be located on the skew corrected image. The swath, on which the PNR number is located, may be identified by using the library stored on the server. The extracted PNR number may be fed into a website of the Indian Railways to obtain the latest status of a train schedule and/or the status of the reservation. The obtained status may be conveyed to the user in real time.

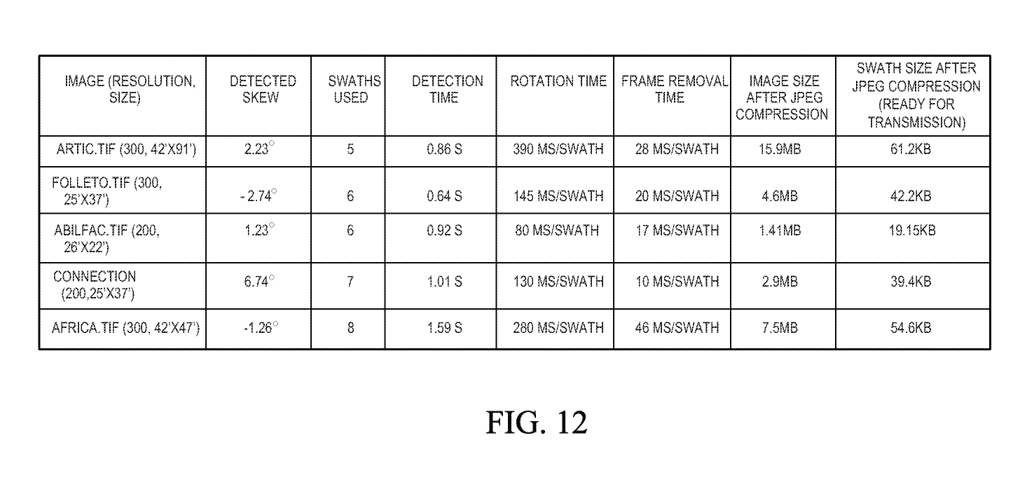

FIG. 12 illustrates a table depicting examples of swath based skew detection and runtimes on a workstation with an Intel Xeon 5160 processor at 3 GHz. The table depicts a first column for the name of the image, a resolution of the image and a size of the image. The second column depicts detected skew angle of the image from the first column. The third column in the table depicts the number of swaths used for detecting the skew angle for the images of the first column. The fourth column in the table depicts a time that is the time required for detecting the skew angle of the images of the first column. The fifth column in the table depicts rotation time that is the time required for rotating the images of the first column by the detected skew angle. The sixth column in the table frame removal time that is the time required for removing the detected frames from the images of the first column. The seventh column in the table depicts a size of the Images of the first column after JPEG compression. The eighth column in the table depicts a size of the swath of the images of the first column after JPEG compression.

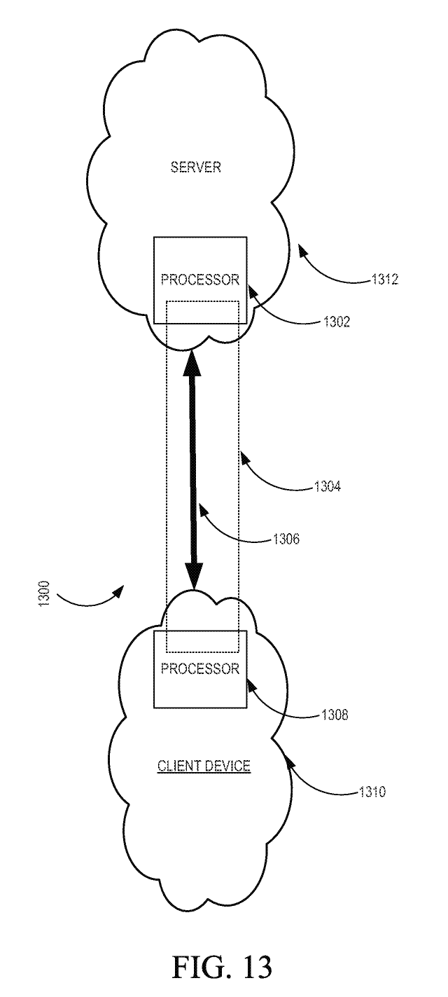

FIG. 13 illustrates a block diagram of a system 1300 for pipelined image processing, according to one embodiment. The system 1300 may comprise a server 1312 connected to a client device 1310 via a network 1306. The server 1300 may include one or more processors 1302. The client device 1310 may also include a processor 1308. The server 1312 and the client device 1310 may include memory device (not shown) to store instructions for pipelined image processing. The processors 1302 and 1308 and the memory devices on server 1312 and client device 1310 may form a pipelined image processing module 1304.

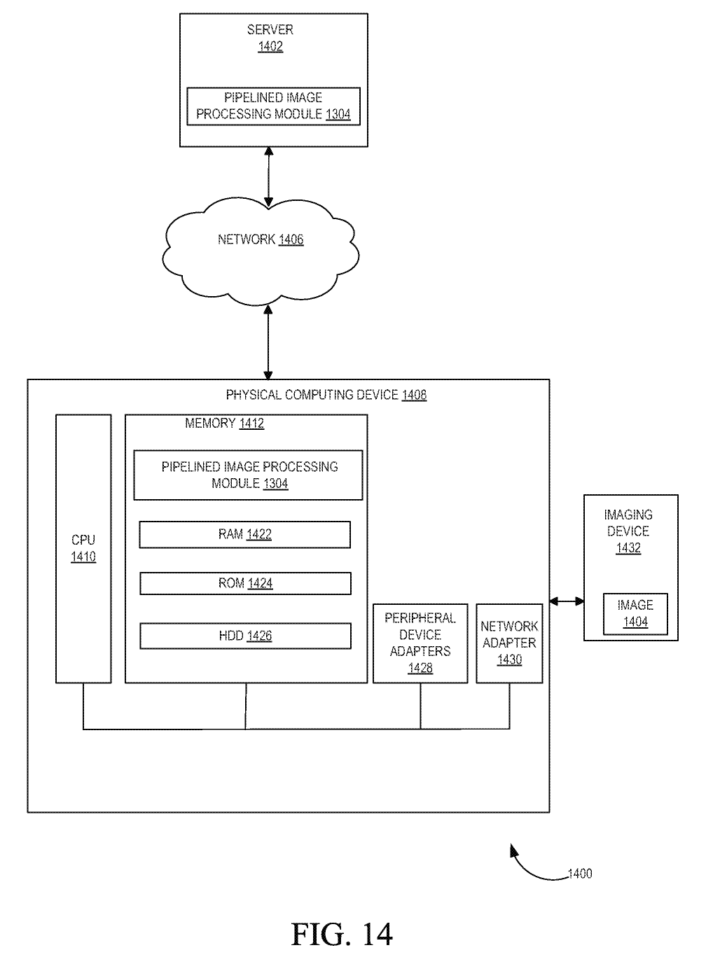

FIG. 14 illustrates a block diagram (1400) of a system for pipelined image processing using the pipelined image processing module 1304 of FIG. 13, according to one embodiment. Referring now to FIG. 14, an illustrative system (1400) for processing an image includes a physical computing device (1408) that has access to an image (1404) captured by the imaging device (1432). In the present example, for the purposes of simplicity in illustration, the physical computing device (1408) and the server (1402) are separate computing devices communicatively coupled to each other through a connection to a network (1406). However, the principles set forth in the present specification extend equally to any alternative configuration in which the physical computing device (1408) has complete access to an image (1404). As such, alternative embodiments within the scope of the principles of the present specification include, but are not limited to, embodiments in which the physical computing device (1408) and the server (1402) are implemented by the same computing device, embodiments in which the functionality of the physical computing device (1408) is implemented by a multiple interconnected computers (e.g., a server in a data center and a user's client machine), embodiments in which the physical computing device (1408) and the web page server (1402) communicate directly through a bus without intermediary network devices, and embodiments in which the physical computing device (1408) has a stored local copy of the image (1404) to be filtered.

To achieve its desired functionality, the physical computing device (1408) includes various hardware components. Among these hardware components may be at least one processing unit (1410), at least one memory unit (1412), peripheral device adapters (1428), and a network adapter (1430). These hardware components may be interconnected through the use of one or more busses and/or network connections.

The processing unit (1410) may include the hardware architecture necessary to retrieve executable code from the memory unit (1412) and execute the executable code. The executable code may, when executed by the processing unit (1410), cause the processing unit (1410) to implement at least the functionality of processing the image (1404) and semantically according to the methods of the present specification described below. In the course of executing code, the processing unit (1410) may receive input from and provide output to one or more of the remaining hardware units.

The memory unit (1412) may be configured to digitally store data consumed and produced by the processing unit (1410). Further, the memory unit (1412) includes the pipelined image processing module 1304 of FIG. 13. The memory unit (1412) may also include various types of memory modules, including volatile and non-volatile memory. For example, the memory unit (1412) of the present example includes Random Access Memory (RAM) 1422, Read Only Memory (ROM) 1424, and Hard Disk Drive (HDD) memory 1426. Many other types of memory are available in the art, and the present specification contemplates the use of any type(s) of memory in the memory unit (1412) as may suit a particular application of the principles described herein. In certain examples, different types of memory in the memory unit (1412) may be used for different data storage needs. For example, in certain embodiments the processing unit (1410) may boot from ROM, maintain non-volatile storage in the HDD memory, and execute program code stored in RAM.

The hardware adapters (1428, 1430) in the physical computing device (1408) are configured to enable the processing unit (1410) to interface with various other hardware elements, external and internal to the physical computing device (1408). For example, peripheral device adapters (1428) may provide an interface to input/output devices to create a user interface and/or access external sources of memory storage. Peripheral device adapters (1428) may also create an interface between the processing unit (1410) and an imaging device (1432) or other media output device. The physical computing device (1408) may be further configured to instruct the imaging device (1432) to capture one or more images.

A network adapter (1430) may provide an interface to the network (1406), thereby enabling the transmission of data to and receipt of data from other devices on the network (1406), including the server (1402).

The above described embodiments with respect to FIG. 14 are intended to provide a brief, general description of the suitable computing environment 1400 in which certain embodiments of the inventive concepts contained herein may be implemented.

As shown, the computer program includes the pipelined image processing module 1404 for processing the image captured on the imaging device (1432). For example, the pipelined image processing module 1404 described above may be in the form of instructions stored on a non-transitory computer-readable storage medium. An article includes the non-transitory computer-readable storage medium having the instructions that, when executed by the physical computing device 1408, causes the computing device 1408 to perform the one or more methods described in FIGS. 1-14.

In various embodiments, the methods and systems described in FIGS. 1 through 14 is easy to implement. Furthermore, the above mentioned system may be simple to construct and efficient in terms of processing time required for processing the image. Further, the above mentioned methods and systems may be adaptive to different types of imaging devices since the processing of the image is carried out in a pipelined network environment. In addition, the above mentioned methods and systems may be adaptive to both the image structure as well as the user's intent, since it can be adjusted by different requirements on image processing granularity.

Further, the methods and systems described in FIGS. 1 through 14, processes the image in a network environment. The methods and systems can be applied to different kind of images. The methods and systems can include a general and platform-independent approach for image processing. The image may be streamed in a pipelined fashion so that further downstream processing on the server can commence without waiting for the whole image to be uploaded on the imaging device. As downstream processing may commence, the user may get a real-time feedback without having to scan the whole image. The document services may be robust to noise and may hence operate for a wide range of document images. For small documents, for example business cards, much of the scanned picture involves artifacts such as frames. So, a priori removal of these artifacts on the client reduces the size of the picture to be streamed thereby saving bandwidth and round-trip-time. A non-sequential set of swaths could be streamed to get real-time response on the client device. Cases where the client cannot buffer all the swaths, for example, displaying a large text document on a display constrained device, the server can aid in transmitting just the needed swaths at full resolution.

Although the present embodiments have been described with reference to specific example embodiments, it will be evident that various modifications and changes may be made to these embodiments without departing from the broader spirit and scope of the various embodiments. Furthermore, the various devices, modules, analyzers, generators, and the like described herein may be enabled and operated using hardware circuitry, for example, complementary metal oxide semiconductor based logic circuitry, firmware, software and/or any combination of hardware, and/or software embodied in a machine readable medium. For example, the various electrical structure and methods may be embodied using transistors, logic gates, and electrical circuits, such as application specific integrated circuit.

What is claimed is:

1. A method for pipelined image processing in a networked computing environment comprising:
receiving one or more swaths of an image by a server from a client device connected via a network;
processing the received one or more swaths on a swath by swath basis to obtain one or more image quality parameters;
determining whether the obtained one or more image quality parameters are equal to or above a predetermined threshold level; and
sending the obtained one or more image quality parameters to the client device for further processing of the image based on the determination.

2. The method of claim 1, wherein the one or more image quality parameters are invoked based on an input from a user.

3. The method of claim 1, wherein the one or more image quality parameters are invoked based on identification of the image type.

4. The method of claim 1, wherein receiving the one or more swaths of the image comprises receiving a predetermined number of swaths.

5. The method of claim 4, wherein the predetermined number of swaths of the image is based on an identification of the image type.

6. The method of claim 4, wherein the predetermined number of swaths is based on a bandwidth of the network between the server and the client device.

7. The method of claim 4, wherein the predetermined number of swaths is based on a resolution of the image.

8. The method of claim 4, wherein the one or more swaths are a non-sequential collection of the one or more swaths of the image to be processed.

9. The method of claim 1, wherein receiving the one or more swaths of the image by the server from the client device connected via the network, comprises:
determining, on the client device, the one or more image quality parameters to be determined for the image processing and mapping the one or more image quality parameters to be determined on the server;
sending a request to the server for determining the one or more image quality parameters for the image processing;
receiving from the server, a request for swath information for determining the one or more image quality parameters, wherein the swath information comprises a number of the one or more swaths and a size of the one or more swaths required for determining the one or more image quality parameters;
mapping the swath information required by the server to the one or more swaths available on the client device; and
sending the requested swath information to the server.

10. A system for pipelined image processing in a networked computing environment comprising:
a client device having a client memory; and
a server device having server memory coupled to the client device via a network; and
a pipelined image processing module residing in the client memory and the server memory; wherein the server receives one or more swaths of an image from the client device via the network, and wherein the pipelined image processing module is configured to:
process the received one or more swaths on a swath by swath basis to obtain one or more image quality parameters;
determine whether the obtained one or more image quality parameters are equal to or above a predetermined threshold level; and
send the obtained one or more image quality parameters to the client device for further processing of the image based on the determination.

11. The system of claim 10, wherein receiving the one or more swaths of the image by the server from the client device connected via the network, comprises:
determining, on the client device, the one or more image quality parameters to be determined for the image processing and mapping the one or more image quality parameters to be determined on the server;
sending a request to the server for determining the one or more image quality parameters for the image processing;
receiving from the server, a request for swath information for determining the one or more image quality parameters, wherein the swath information comprises a number of the one or more swaths and a size of the one or more swaths required for determining the one or more image quality parameters;
mapping the swath information required by the server to the one or more swaths available on the client device; and
sending the requested swath information to the server.

12. The system of claim 10, wherein receiving the one or more swaths of the image comprises receiving a predetermined number of swaths of a predetermined size.

13. The system of claim 12, wherein the predetermined number of swaths of the predetermined size is determined based on a bandwidth of the network between the client device and the server.

14. The system of claim 11, wherein the one or more swaths are a non-sequential collection of the one or more swaths of the image to be processed.

15. A non-transitory computer-readable storage medium for pipeline image processing in a networked computing environment, having instructions that, when executed by a computing device, causes the computing device to perform a method comprising:
receiving one or more swaths of an image by a server from a client device connected via a network;
processing the received one or more swaths on a swath by swath basis to obtain one or more image quality parameters;
determining whether the obtained image quality parameter is equal to or above a predetermined threshold level; and
sending the obtained image quality parameter to the client device for further processing of the image based on the determination.
